(19) United States
(12) Patent Application Publication
(10) Pub. No.: US 2026/0275791 A1
(43) Pub. Date: Sep. 17, 2026

(54) CLOSING DEVICE FOR A SLIDING DOOR DEVICE AND SLIDING DOOR DEVICE

(71) Applicant: HAWA SLIDING SOLUTIONS AG, Mettmenstetten (CH)

(72) Inventors: Ralph EGGER, Hauptwil (CH); Marek LACH, Obfelden (CH)

(73) Assignee: HAWA SLIDING SOLUTIONS AG, Mettmenstetten (CH)

(21) Appl. No.: 19/473,327

(22) PCT Filed: Apr. 8, 2024
(86) PCT No.: PCT/EP2024/059496

§ 371 Date: Oct. 7, 2025

(30) Foreign Application Priority Data
Apr. 14, 2023 (EP) 23168097.6

(51) Int. Cl. E05F 1/16; E05F 5/00

(52) U.S. Cl. CPC E05F 1/16; E05F 5/003; E05Y 2201/21; E05Y 2201/47; E05Y 2201/654; E05Y 2201/668; E05Y 2201/688; E05Y 2800/678; E05Y 2900/132

(57) ABSTRACT

A closing device for a sliding door with at least one sliding door, includes a device body, displaceable first roller set, stationary second roller set, tension spring connected by first and second spring end pieces to the first and second roller sets, and pull rope guided with loops around the first and second roller sets and connecting with a first rope end piece directly or indirectly to the first roller set or the device body and leads out of the closing device with a second rope end piece. The device body includes a holding rail holding a roller carriage with carriage body coupled to the first spring end piece and first mounting shaft whereby the first roller set is supported, the device body connects to a connection device connecting to a drive unit drive body, and the connection device holds a deflection pulley around which the tension spring is guided.

The invention relates to a closing device for a sliding door device and a sliding door device, such as a sliding door device for a building or a piece of furniture.

Various closing devices are known from the prior art, including closing devices with a pull rope and an elongated tension spring, by means of which sliding doors can be moved automatically from a first end position to a second end position. Such closing devices normally have a complex structure, as on the one hand the pull rope must be guided around at least two cable pulleys and on the other hand the elongated tension spring must be arranged accordingly. Typically, the parts of the device are mounted in a housing, which involves a corresponding degree of effort.

Arrangements with a sliding door that can be moved along a running rail by means of drive units are known, for example, from U.S. Pat. Nos. 6,052,867A, 6,418,588B1 or 9,341,019B2. U.S. Pat. No. 6,052,867A discloses a sliding door with a glass plate that can be connected to drive units that are guided in a running rail by means of connecting fittings. These connecting fittings comprise a mounting device which is inserted into an opening in the glass plate and is connected to the associated drive unit by a threaded rod. U.S. Pat. No. 6,418,588B1 discloses a sliding door with a wooden panel which can be connected to drive units by means of connecting fittings. These connecting fittings each comprise a mounting part which is mounted on the upper side of the sliding door and is connected to the associated drive unit by a threaded rod. U.S. Pat. No. 9,341,019B2 discloses a sliding door with a wooden panel which can be connected to drive units by means of connecting fittings. These connecting fittings comprise a mounting device which is mounted in a mounting groove on the upper side of the sliding door.

EP0417822A1 discloses a device with a vertically displaceable sliding door.

CA2096671A1 discloses an automatic closing device with a housing, with a pull rope, with a tension spring in the form of a spiral spring, with a displaceably held first roller set and a stationarily held second roller set. The displaceably held first roller set is connected on the one hand to the tension spring and on the other hand to the pull rope, which is guided with a number of loops around the two roller sets and out of the housing. A mutual displacement of the two roller sets by a distance results in the pull rope being guided out of the housing with an extension length that corresponds to twice the distance of the mutual displacement of the roller sets multiplied by the number of loops. During this process, the tension spring, which is connected on the one hand to the slidably held first roller set and on the other hand to the housing via an adjusting device, is stretched by the distance. The tension spring and the two roller sets are arranged axially one behind the other, which is why the arrangement takes up a relatively large amount of space and the extension length is relatively short. The extension length can be increased according to the number of loops and with a tension spring that has a shorter spring travel and a higher spring constant. With additional loops, the number of cable pulleys of the pulley sets and their dimensions increase. Springs with a higher spring constant also have larger dimensions and less favourable behaviour. Overall, the dimensions of the closing device increase, which makes the installation of the locking device in a running rail questionable or requires an increase in the cross-section of the running rail.

EP3095351A1 discloses a closing device for a movable furniture part with a displaceably mounted carriage, in which a tension spring and a pull rope and an activation mechanism are provided. The tension spring can be locked in a tensioned state by the activation mechanism and can be released after the carriage has been moved to a release position, so that the furniture part is automatically pulled into an end position by means of the closing device. This closing device is therefore not suitable for guiding a sliding door over a greater distance from one end position to another.

WO2020030385A1 discloses a closing device with a tension spring in the form of a coil spring and a pull rope, which is guided with several loops around a displaceable first roller set and around a stationary second roller set and further to an exit of the closing device. The tension spring and the roller sets are again arranged axially one behind the other, which is why the closing device must again be relatively large so that the pull rope can be pulled out of the closing device with a greater length. A further disadvantage is that parts of the device, in particular a stationary roller set, have to be mounted in a housing, which is associated with corresponding effort.

Closing devices of this type can also cause noise when the sliding door is moved, which is undesirable in flats, commercial buildings or hotels.

EP2090732A2 discloses a brake fitting with a guide tube for a flap held pivotably by a furniture body and thus not for a device with a sliding door which is to be guided automatically from one door stop to the other. The brake fitting comprises a pull cable, which is attached to the flap with one end piece, guided only around a deflection wheel and connected to the guide tube with another end piece. A sliding piece is slidably mounted in the guide tube, which holds the deflection wheel and is connected to the spring cable. The spring cable is held firmly at a first end piece, guided around a sleeve and connected to the sliding piece with a second end piece. Instead of two sets of pulleys, this device therefore only comprises a single deflection wheel. This device therefore makes it possible to brake the turn of a flap, but not to drive a sliding door. The sleeve around which the spring cable is guided is held rotatably by means of an axle which is inserted into longitudinal slots in the guide tube. The assembly of this device is therefore relatively complex. Even the installation of the sleeve inside the guide tube requires skill. Subsequently, the spring cable must be inserted into the guide tube and guided around the sleeve, which may require a special tool. The device of EP2090732A2 is therefore unsuitable for driving a sliding door and, despite the reduced number of device parts, can only be assembled with relatively high effort.

The present invention is therefore based on the object of providing an improved closing device for a sliding door device and an improved sliding door device for a building or a piece of furniture equipped with such a closing device.

The closing device shall be simple in design and shall be manufactured and assembled with little effort. It shall be possible to dispense with connecting means or assembly means, such as screws or the like, so that on the one hand a reduction in material results and assembly work for the installation of the connecting means and assembly means is no longer necessary.

The closing device shall be realisable with reduced dimensions and improved properties. Despite its reduced dimensions, the pull rope should be able to be pulled out of the closing device over a relatively large or increased extension length, so that a sliding door, such as a wardrobe door, can be moved over a greater distance and automatically pulled back again.

The tension spring should be able to be selected with physical properties that optimise the properties of the closing device. The tension spring should have the smallest possible diameter so that the closing device can be designed to be as slim as possible.

The closing device shall work powerfully, but largely wear-free and noiselessly.

The arrangement with the sliding door, which, when released, is automatically pulled into a starting position by means of the closing device, shall be able to be installed conventionally with regard to the small dimensions of the closing device and not require any special adaptations. The closing device shall be able to be installed within running rails having a reduced cross-section.

Any sliding door device with an automatically driven sliding door shall advantageously be realisable by using the closing device. The sliding door arrangement shall allow a sliding door to be moved automatically over a wide range from one end stop to another end stop, in particular between an open or closed end position in one direction or the other. Disturbing noises or a hard stop shall be avoided.

This problem is solved with a closing device according to claim 1 and a sliding door device according to claim 13, which is equipped with at least one such closing device. Advantageous embodiments of the invention are specified in further claims.

The closing device, which is provided for a sliding door device having at least one sliding door, comprises a device body, a first roller set that is held displaceable, a second roller set that is held stationary by the device body, a tension spring, which is connected by a first spring end piece directly or indirectly to the first roller set and which is connected by a second spring end piece directly or indirectly to the second roller set, and a pull rope, which is guided with several loops around the first roller set and the second roller set and which is connected with a first rope end piece directly or indirectly to the first roller set or to the device body and which is led out of the closing device with a second rope end piece.

The first roller set has several first cable pulleys, which preferably lie against each other and are held coaxially aligned to each other by a first mounting shaft. The second roller set has several second cable pulleys, which preferably lie against each other and are held coaxially aligned to each other by a second mounting shaft.

Each of the cable pulleys preferably has a circumferential groove within which the pull rope is partially received and guided.

Preferably, the cable pulleys can rotate independently of each other. The cable pulleys are therefore preferably mounted individually and preferably fitted with a high-quality plain bearing or a ball bearing. The use of high-quality bearings, especially ball bearings, largely eliminates friction losses and signs of wear. The pull rope can therefore always be pulled out of the closing device with the same tensile force, even after a long period of operation. Preferably, self-lubricating plain bearings or self lubricating ball bearings are used so that the closing device operates maintenance-free.

According to the invention it is provided,
that the device body comprises a holding rail, which displaceably holds a roller carriage that comprises a carriage body,
that the roller carriage is coupled to the first spring end piece and is provided with a first mounting shaft by which the first roller set is rotatably supported,
that the device body is integrally, force-fittingly or form-fittingly connected to a connection device which is connected or connectable to a drive body of a drive unit, and
that the connection device by means of a bearing shaft rotatably holds a deflection pulley around which the tension spring is guided.

In the relaxed state, the tension spring can extend over the entire length of the closing device on one side of the deflection pulley and can also be stretched on the other side of the deflection pulley by a length which in turn corresponds at least approximately to the entire length of the closing device. The physical properties of the tension spring can therefore be selected almost at will, so that the closing device can be designed as desired and provided with an advantageous working behaviour. If a lower spring constant is present, the tension spring can be realised with smaller dimensions, in particular with a smaller diameter, which is why the closing device can also be realised with a smaller width.

If the tension spring is guided around the deflection pulley in such a way that the spring end pieces lie vertically on top of each other, this does not result in a widening of the closing device. Due to the smaller diameter of the tension spring, the width of the closing device is not determined by the tension spring. The closing device can therefore be realised with a reduced width so that it is preferably dimensioned in such a way that it can be inserted into the sliding door, typically from below, through a longitudinal slot in the running rail through which the drive units are connected to the sliding door. Alternatively, the closing device is connected to the associated drive unit and inserted into the end face of the running rail at a rail end piece.

By extending the spring travel, the dimensions of the closing device can also be significantly reduced in the axial direction parallel to the running rail, while still leaving a long working path that allows a sliding door remote from a door opening to be pulled in front of the door opening and the door opening to be fully opened or closed.

Preferably, the tension spring is guided around the deflection pulley in such a way that their end pieces are aligned parallel to each other and point in the same direction.

As the tension spring can be stretched over the entire length of the closing device, the first roller set can also be moved over this length, which is why larger working paths, i.e. larger door openings and wider doors, can be operated even with small dimensions of the closing device.

The tension spring is preferably helical and/or preferably essentially polygonal or cylindrical. Preferably, the tension spring is made of metal, plastic or rubber or a combination thereof, for example a combination of rubber and plastic. The tension spring is preferably made of rubber, in particular soft rubber, latex, caoutchouc or an elastomer. Preferably, the tension spring or the core of the tension spring is formed by a plurality of bundled threads of rubber, in particular soft rubber, latex, caoutchouc or an elastomer.

Preferably, the tension spring, which is made of metal and/or rubber and/or plastic and forms the spring core, is enclosed by a sheathing. The sheathing is manufactured in such a way that the elongation properties, in particular the spring constant, are not changed or are only changed as desired. The sheathing can therefore contribute to the elasticity of the tension spring or only serve as a protective element that protects the tension spring against external influences, in particular increased abrasion.

The sheathing is firmly or loosely connected to the metal and/or rubber and/or plastic spring core and preferably has inward and/or outward good sliding properties.

Preferably, especially if the sheathing is firmly connected to the spring core, the sheathing is a stretchable coating or a stretchable mesh.

The sheathing is preferably made of rubber or plastic or is braided from a plurality of threads consisting of rubber or plastic. The threads are made of polypropylene or polyester, for example.

The sheathing protects the enclosed spring core against external influences and at the same time protects the deflection pulley against undesirable influences from the tension spring, if it is a metal coil spring, for example. For example, the sheathing prevents the coils of the tension spring, which is also subject to stretching when in contact with the deflection pulley, from mechanically stressing the deflection pulley and damaging it over a longer period of time.

The tension spring made of rubber or an elastomer has a high elasticity and a high tensile force, is corrosion-free and works practically without noise.

The device body of the closing device, which holds the roller carriage with the first roller set, the second roller set and the deflection pulley, can have a one-piece or modular design. In the case of a modular design, in which at least two modules are provided, the device body can be manufactured particularly easily.

In preferred embodiments, it is provided,
that the device body comprises a connecting body which is connectable to a first end piece of the holding rail and which forms a structural element of the connection device; and/or
that the device body comprises a terminating body which is connectable to a second end piece of the holding rail and which is provided with a second mounting shaft by which the second roller set is rotatably held.

Hence, together with the connecting body and/or the terminating body, the holding rail forms the modular device body, which holds the moving parts of the closing device. The connecting body or the terminating body can also be connected in one piece with the holding rail. Preferably, however, the connecting body and the terminating body can be connected to and disconnected from the holding rail.

Preferably, the connecting body and the terminating body can be pushed form-fittingly into the holding rail and are held therein free of play or at least approximately free of play with respect to the longitudinal axis of the holding rail. The connecting body and the terminating body can therefore be easily fixed by applying force in the direction of the holding rail.

In preferred embodiments, it is provided that the holding rail has one or more guiding tracks along which the roller carriage is displaceably mounted. In preferred embodiments, these guiding tracks are also used for mounting the connecting body and/or the terminating body.

Preferably, the holding rail comprises two corresponding guiding tracks on the outer sides and/or the inner sides, which ensure that the roller carriage and the connecting body and/or the terminating body are held on both sides.

For coupling with the guiding tracks, the carriage body has one or more guide elements, each of which is held by the associated guiding track.

The connecting body has one or more first support elements, each of which is held by the associated guiding track.

The terminating body has one or more second support elements, each of which is held by the associated guiding track.

The guide elements of the roller carriage as well as the first support elements of the connecting body and the second support elements of the terminating body are preferably designed as runners, cams, grooves or rollers so that they can be held form-fittingly by the complementary guiding tracks, for example grooves, channels or ribs. Preferably, at least the guide elements of the roller carriage are designed as rollers that can run friction-free in the associated guiding tracks.

In preferred embodiments, it is provided that the connection device is pulled by the tension spring against the first end piece of the holding rail and is held with the connecting body at the first end piece of the holding rail, and/or that the terminating body is pulled by the tension spring against the second end piece of the holding rail and is held at the second end piece of the holding rail. Since both, the connection device, which comprises the connecting body, and the terminating body, are connected to the tension spring and the tension spring is preferably always kept under tension, the tension spring is used to connect the connection device to the connecting body on the one hand and the support device to the holding rail on the other.

When installing the closing device, the first end piece of the tension spring is connected to the roller carriage before it is inserted into the holding rail. The connecting body and the terminating body are therefore fixed by connecting the second spring end piece to the second coupling device, which is connected to the terminating body. The connection device is therefore pulled against the first end piece of the holding rail by the tension spring and held with the connecting body at the first end piece of the holding rail and/or the terminating body is pulled against the second end piece of the holding rail by the tension spring and held at the second end piece of the holding rail.

In further preferred embodiments, it is provided
that the first spring end piece comprises a first coupling part which is an integral part of the first spring end piece or which is connected to the first spring end piece, and which is connected to a first coupling device which is fixedly or slidably connected to the first roller set, and/or
that the second spring end piece comprises a second coupling part which is an integral part of the second spring end piece or which is connected to the second spring end piece, and which is connected to a second coupling device which is fixedly or slidably connected to the device body.

The first coupling device and/or the second coupling device is preferably designed as a tensioning device and is, for example, displaceably mounted and can be optionally positioned along a ridge area, for example with an adjusting screw, in order to set a desired spring preload.

The first coupling device and/or the second coupling device can also be provided with several latching elements arranged along a line, into which the associated spring end piece can optionally be hooked.

Preferably, the tension spring is pre-tensioned by selecting a correspondingly shorter distance than the distance between the coupling devices. The tension spring can therefore be stretched and pretensioned to this distance during assembly.

Alternatively, the first coupling part and/or the second coupling part can also be adjustable. For example, the first coupling part and/or the second coupling part is rotatably connected to the associated spring end piece and provided with an external thread, so that the first coupling part and/or the second coupling part can be screwed, for example, into a thread that is in the device body or in a device part that is connected to the device body. To actuate the first or second coupling part, it is preferably provided with an engagement element that can be positively connected to a tool that can be actuated manually.

The device body comprises at least the holding rail, from which a roller carriage, which has a carriage body, is displaceably held, wherein the carriage body is coupled to the first spring end piece and is provided with a mounting shaft, from which the first roller set is rotatably held. The holding rail and the roller carriage, which can be moved along the holding rail, result in a stable structure of the closing device. Furthermore, this results in a smooth and controlled movement sequence when the closing device is actuated. There are also advantages when assembling the closing device, especially when inserting or inserting the pull rope. The controlled guidance of the sliding cable pulley prevents lateral movements that could cause noise.

The device body can be made of metal or plastic. The carriage body can also be made of metal or plastic. The pull rope is also made of metal or plastic and preferably has a braid of threads made of metal and/or plastic.

The holding rail preferably comprises an upper side, along which the roller carriage is displaceable, and a lower side. The deflection pulley is preferably held at one end of the holding rail by means of a bearing shaft, which is preferably held on both sides by an axle bearing, which is connected to the device body or integrated into the device body.

The first spring end piece is preferably guided from the deflection pulley on the upper side of the holding rail to the roller carriage. The second spring end piece is preferably guided from the deflection pulley on the lower side of the holding rail to the second coupling device, which is fixed or slidably connected to the device body.

The carriage body is preferably connected to the first coupling device in a fixed or movable manner, optionally in one piece.

Preferably, the carriage body is provided with at least one guide element in the form of a slide runner, which is positively held by the holding rail. Preferably, the carriage body has two spaced-apart slide runners, which are from-fittingly held in the guiding track on both sides. The guiding track is designed as a holding channel, for example. One or more carriage runners can also engage positively in a holding channel or several holding channels in the holding rail. For example, the holding rail can have a holding channel with inclined flanks that correspond to the inclined flanks of the carriage body. The carriage body can therefore also be advantageously inserted into a holding channel.

Preferably, the holding rail has a track entrance into which the carriage runner or runners can be inserted. The track entrance can preferably be closed with a locking screw so that the roller carriage can no longer detach from the holding rail by itself.

The holding rail can also be provided with a mounting grid into which stop elements can be inserted as required to limit the travel of the roller carriage.

The holding rail can be designed in different ways. For example, it is provided
that the holding rail is plate-shaped and has an upper side and a lower side and that the first spring end piece is guided from the deflection pulley on the upper side of the holding rail to the roller carriage and that the second spring end piece is guided from the deflection pulley on the lower side of the holding rail to the second coupling device; or
that the holding rail is formed in a C-profile or U-profile shape and has two side walls connected to one another by a centrepiece, on the inner sides of which side walls, which face one another, one of the guiding tracks is provided in each case, and that the first spring end piece is guided from the deflection pulley into the holding rail to the roller carriage and that the second spring end piece is guided from the deflection pulley on the lower side of the holding rail to the second coupling device.

The holding rail preferably has the same cross-section over its entire length and can be easily manufactured using a forming process, for example by compression moulding or another extrusion process. As a result, holding rails can be cut to any length.

Preferably, a damping device is provided within the closing device, which connects the carriage body and the device body in such a way that the damping device counteracts the return of the roller carriage. The damping device has, for example, a damping cylinder and a damping piston, which is moved within the damping cylinder by means of a push rod.

The damping cylinder is inserted into the device body, for example, while the push rod is connected or can be connected to the roller carriage. If the push rod is firmly or permanently connected to the roller carriage or connects to the carriage body, damping takes place over the entire distance travelled by the roller carriage and thus also by the sliding door during automatic displacement. Normally, however, it is sufficient if the sliding door and/or the roller carriage is damped in its movement before reaching the end position and an element of the damping device, such as the push rod or the damping cylinder, is contacted for this purpose. For example, a pneumatic or hydraulic damper or an oil damper can be used as a damping device.

The carriage body of the roller carriage can be connected to an associated drive unit in different ways. Preferably, the carriage body is provided in one piece, force-fitting or form-fitting with a connection device, which is connected or connectable in a form-fitting and/or force-fitting or one-piece manner to the drive body of a drive unit, which is displaceable in a running rail.

The device body is preferably connected at the end remote from the connected drive unit to a support wheel, which rolls on the running rail and holds and stabilises the rail device in the selected orientation.

The first rope end piece of the pull rope can be connected to the device body or the roller carriage in any way. Preferably, the first rope end piece is connected to the displaceable first roller set, optionally to the roller carriage, so that the pull rope can also be pulled out of the closing device by the displacement of the displaceable first roller set or the roller carriage.

For example, the first rope end piece can be connected to the carriage body or the device body by means of a screw or coupled to a suspension device. For this purpose, the first rope end piece is preferably provided with a connecting eyelet, a connecting loop or a connecting ring. The first rope end piece can therefore be advantageously hooked onto a hook, for example. The first rope end piece can also be inserted into a clamp, which is then tightened.

The second rope end piece, which has been led out of the closing device, can be connected in the same way or in another way, for example to the running rail or to a device, in particular a retaining device or buffer device, which is connected to the running rail.

In preferred embodiments, the pull rope with the second rope end piece is guided out of the closing device through an exit opening, whereby the stationary second roller set is preferably arranged in the area of the exit opening and the displaceable first roller set is arranged away from the exit opening and can be displaced towards the exit opening. This ensures that a maximum length of the pull rope can be guided out of the closing device. The deflection pulley is preferably arranged at the end of the closing device opposite the exit opening.

The inventive closing device can be used in any arrangement with a sliding door, such as sliding door systems or pieces of furniture, in particular cabinets or the like, to automatically move the sliding door into an end position.

The sliding door is used, for example, for closing a room opening or a wardrobe opening, which is connected on the upper side to a first drive unit and a second drive unit, which are slidably mounted in a running rail. One of the drive units is preferably connected to the closing device in such a way that the closing device is held between the two drives. The inventive closing device can be used, for example, in sliding door arrangements with sliding doors made of wood or glass, as disclosed in the aforementioned U.S. Pat. Nos. 6,052,867A, 6,418,588B1 or 9,341,019B2. The connecting devices described there make it possible to adjust the height of the sliding door.

The sliding door can be moved away from an opening and held in an end position, preferably releasably, by a retaining device and released again by the application of force. The retaining device can be of any design and can have any latching element, for example at least one magnet or at least one retaining clip or a hook.

The running rail extends from a first rail end piece to a second rail end piece. Preferably, a first retaining device with a latching element is arranged at least in the first rail end piece, by means of which the sliding door can be releasably locked in a position in which the tension spring is tensioned. In this case, the second rope end piece of the pull rope is preferably connected directly or indirectly to the second rail end piece.

The invention is explained in more detail below with reference to the drawings. It shows:

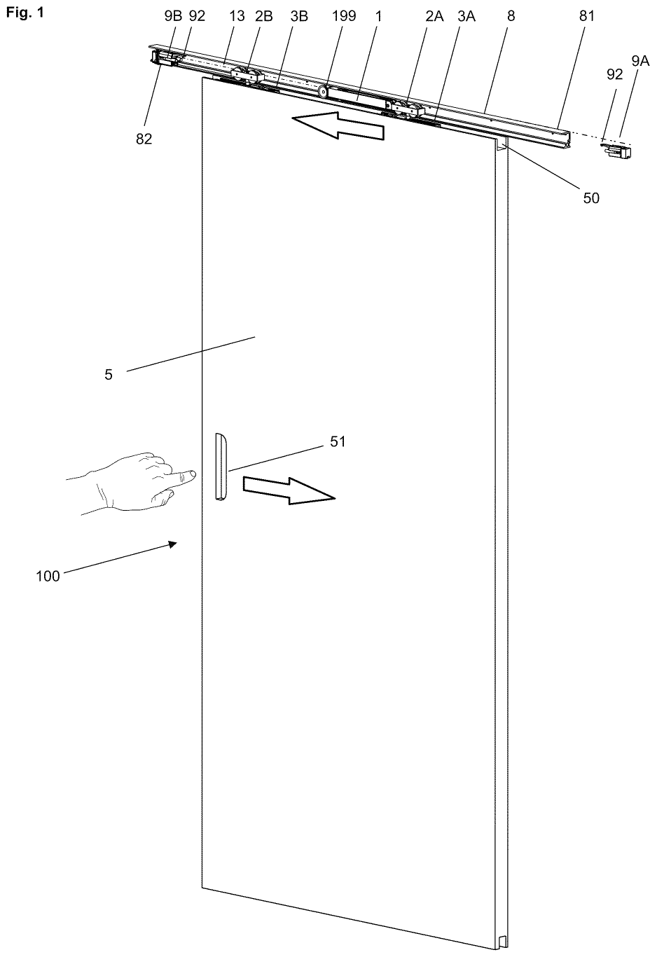

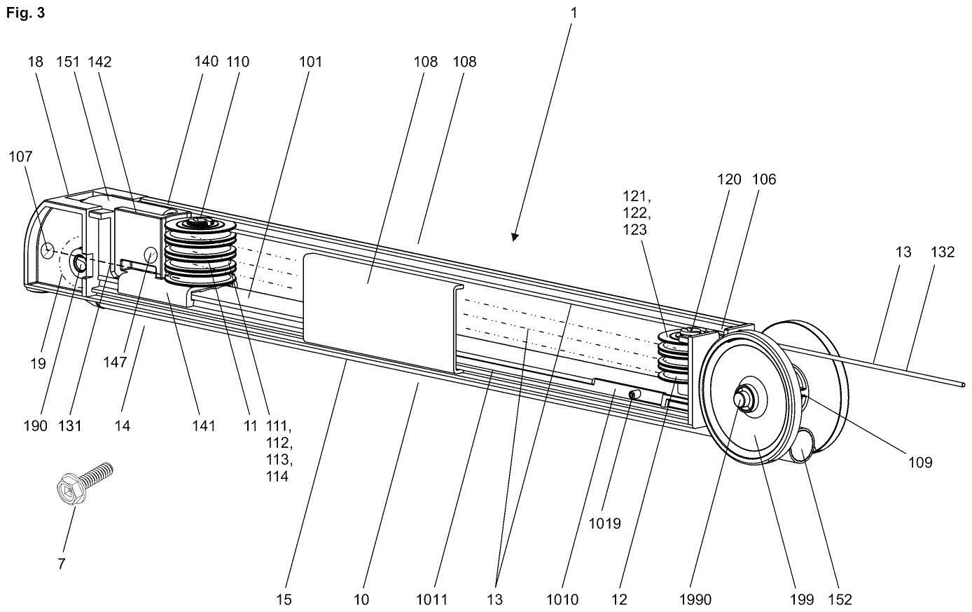

FIG. 1 an inventive sliding door device 100 with a sliding door 5, which is connected on the upper side to two drive units 2A, 2B, which are displaceably mounted in a running rail 8 and can be coupled to a first retaining device 9A after displacement to one side and to a second retaining device 9B after displacement to the other side, wherein the first drive unit 2A is connected to an inventive closing device 1, which comprises a tension spring 15, a displaceably mounted first roller set 11, a stationarily held second roller set 12 and a pull rope 13, which is guided with several loops around the first and second roller set 11, 12 and outwards (see FIG. 3);

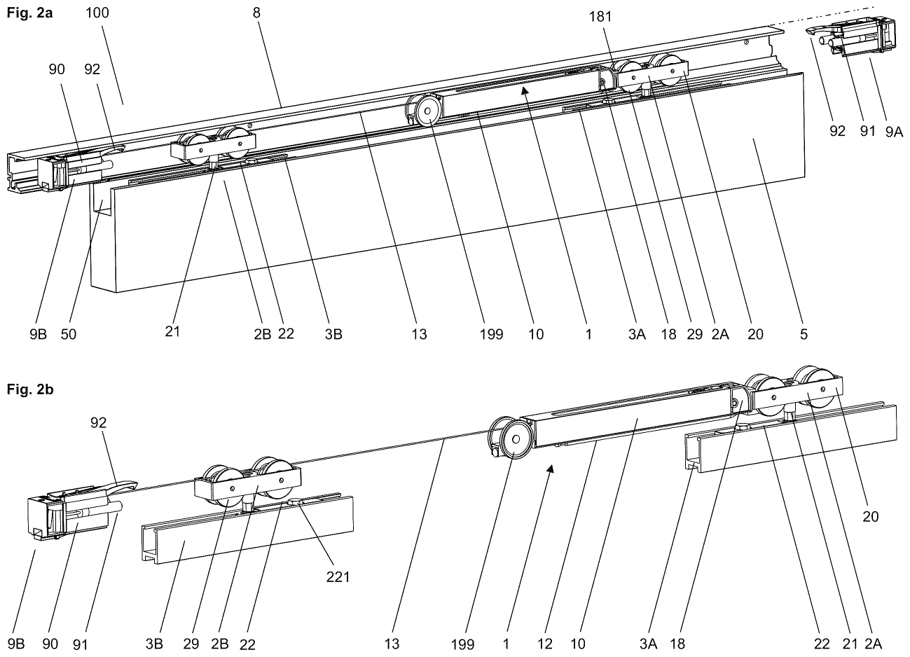

FIG. 2a the upper part of the sliding door arrangement 100 of FIG. 1 with the closing device 1, with the two holding devices 9A, 9B and with the two drive units 2A, 2B, which are anchored by means of mounting rails 3A, 3B in a mounting groove 50 at the upper edge of the sliding door 5;

FIG. 2b in an enlarged view one of the holding devices 9B, the closing device 1 and the two drive units 2A, 2B of FIG. 2a, each comprising a drive body 20, which is connected by a connecting element 21 to a mounting body 22, which is held displaceably and lockably in an associated mounting rail 3A or 3B;

FIG. 3 the closing device 1 of FIG. 1 in a preferred embodiment with a device body 10, which comprises a holding rail 101, by which a roller carriage 14 is displaceably held, with a tension spring 15, which is connected with a first spring end piece 151 to the roller carriage 14 and with a second spring end piece 152 to the device body 10, with a displaceable first roller set 11, which is rotatably and displaceably held by the roller carriage 14 by means of a first mounting shaft 110, with a stationary second roller set 12, which is held rotatably but not displaceably by the device body 10 by means of a second mounting shaft 120, and with a pull rope 13, which is guided with several loops around the first and second roller sets 11, 12 and is connected to the roller carriage 14 or the device body 10 with a first rope end piece 131 and is led out of the closing device 1 with a second rope end piece 132;

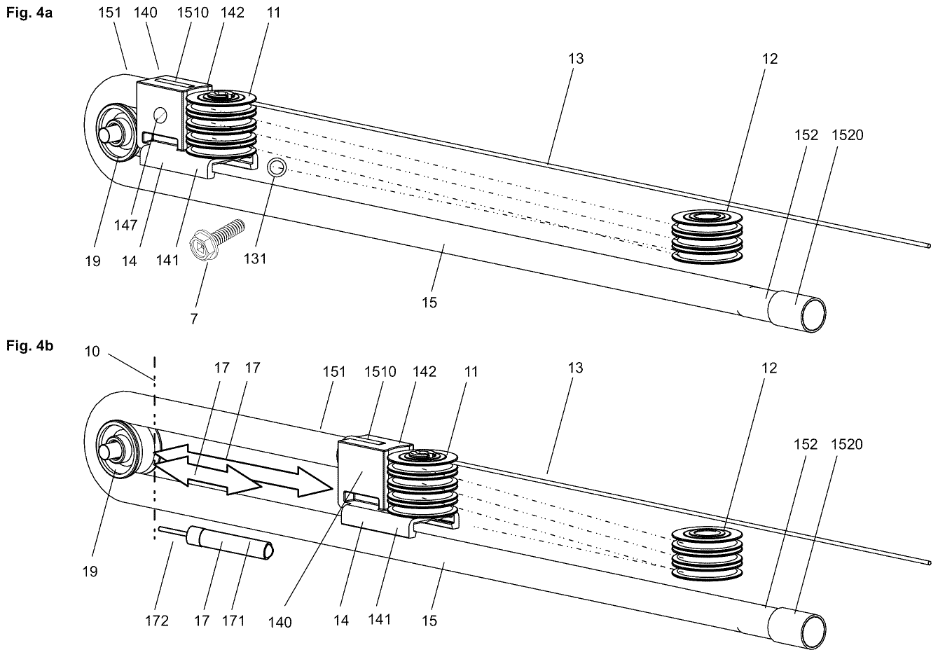

FIG. 4a a part of the closing device 1 of FIG. 3 with the tension spring 1, which is guided by a deflection pulley 19 and connected to the first coupling device 142 of the roller carriage 14 by the first spring end piece 151;

FIG. 4b the part of the closing device 1 of FIG. 4a with the roller carriage 14 displaced against the stationary second roller set 12 and optionally provided damping devices 17, which are connected to the device body 10 or the carriage body 140 or to the device body 10 and the carriage body 140;

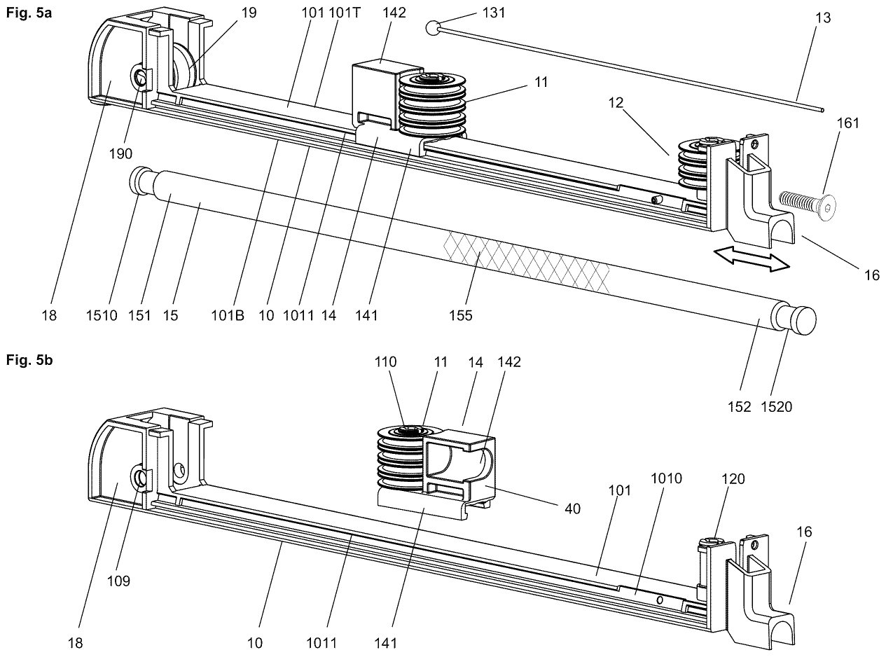

FIG. 5a the device body 10 of the closing device 1 of FIG. 3 with the deflection pulley 19 and the roller carriage 14 as well as with the tension spring 15, which has been detached from the device body 10 and the roller carriage 14 and which preferably has a round or polygonal cross-section;

FIG. 5b the device body 10 of FIG. 5a and the roller carriage 14 detached from it, which has been rotated through 180°, with a view to the first coupling device 142 and the carriage runners 141;

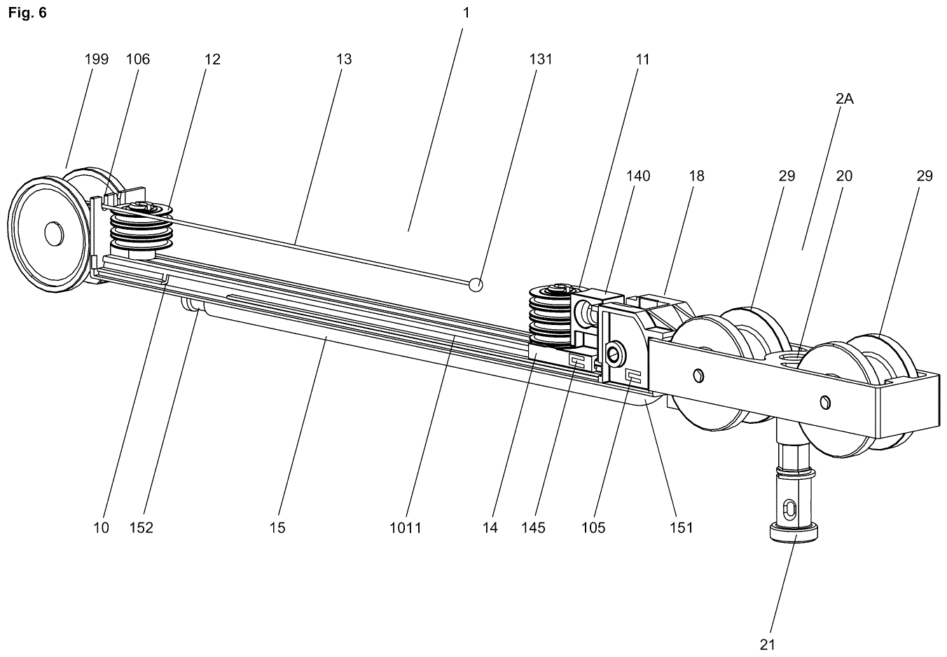

FIG. 6 the closing device 1 of FIG. 3 with the device body 10, which has a connection device 18 that is connected or connectable in a form-fitting and/or force-fitting or integral manner to the drive body 20 of the associated drive unit 2A;

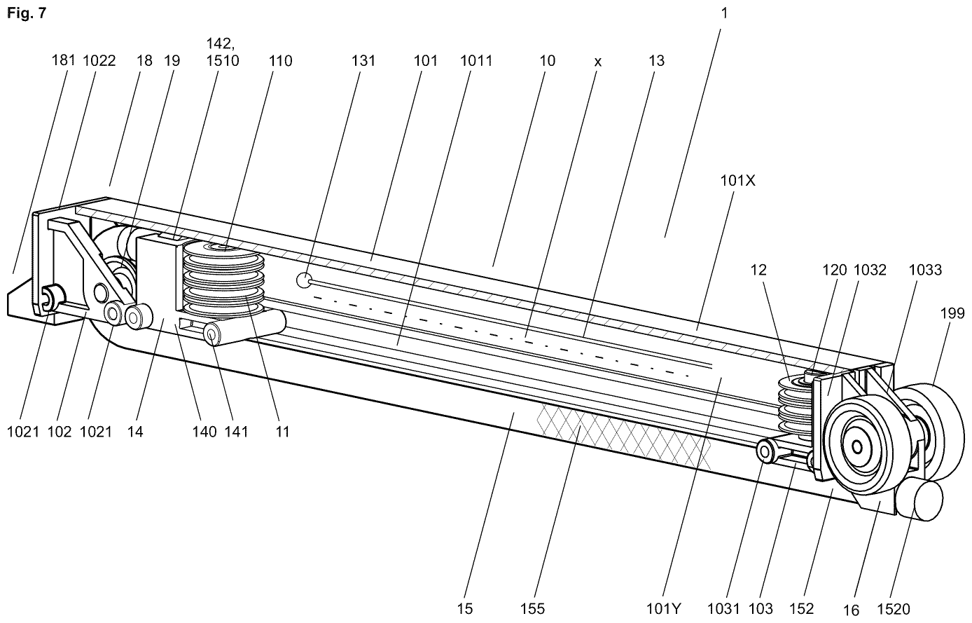

FIG. 7 the inventive closing device 1 of FIG. 1 in a further preferable embodiment with a modular device body 10, which comprises a holding rail 101, into which on one side a connecting body 102 of the connection device 18 and on the other side a terminating body 103, which holds the second roller set 12, are inserted, and with the mounted tension spring 15, which pulls and fixes the connecting body 102 and the terminating body 103 against the holding rail 101;

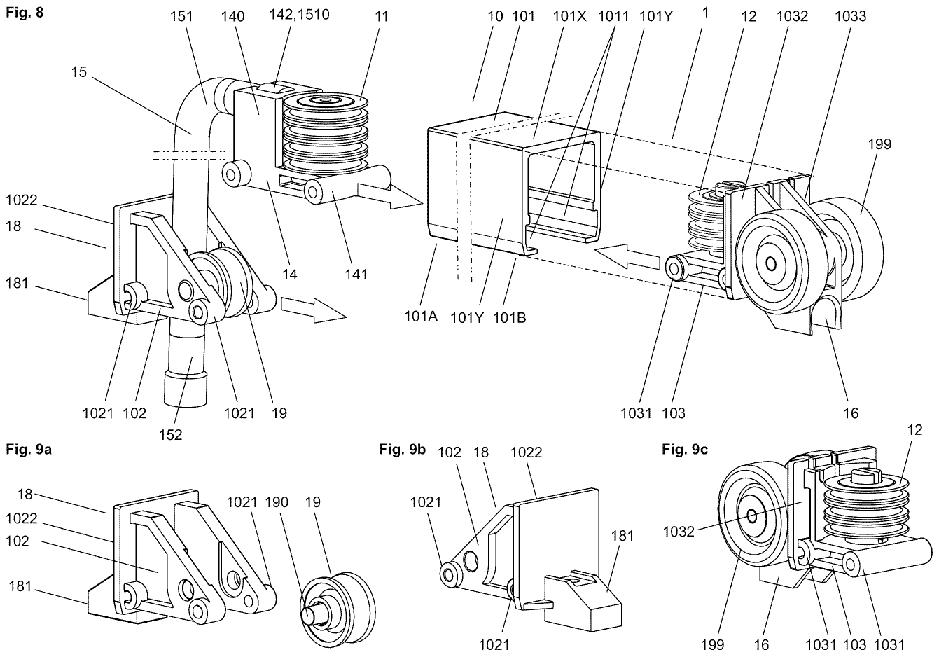

FIG. 8 the closing device 1 of FIG. 7 during assembly, which is done in a few simple steps;

FIG. 9a the connection device 18 with the connecting body 102 and the deflection pulley 19 detached from the connecting body 102;

FIG. 9b the connecting body 18 of FIG. 9a from the other side with a coupling element 181, through which the closing device 1 can be connected to a drive unit 2A according to FIG. 1; and

FIG. 9c the terminating body 103, which carries the second roller set 12 and which preferably holds a support wheel 199, which can roll in the running rail 8 of FIG. 1.

FIG. 1 shows an inventive sliding door device 100 with a sliding door 5. The sliding door 5 is connected on the upper side to a first drive unit 2A and a second drive unit 2B, which are displaceably mounted in a running rail 8. The running rail 8, which is shown partially dotted, extends over a length that allows a door opening or room opening to be fully opened or closed. The running rail 8 comprises a first rail end piece 81, in which a first retaining device 9A is preferably arranged, and a second rail end piece 82, in which a second retaining device 9B is preferably arranged. The two retaining devices 9A, 9B are positioned such that, in the respective open or closed end position of the sliding door 5, they can co-operate with the associated drive unit 2A or 2B and preferably brake it with at least one damping device 91 and/or preferably hold it in the end position reached in a force-locking and releasable manner with at least one latching element 92.

The drive units 2A, 2B are connected to the sliding door by mounting rails 3A, 3B, which are held in a mounting groove 50 on the upper side of the sliding door 5. However, the drive units 2A, 2B can also be connected to the sliding door 5 in any other way, as described above with reference to the prior art.

On the side facing the second drive unit 2B, the first drive unit 2A is connected to a closing device 1, by means of which the sliding door 5 can always be moved automatically in the closing direction towards the second retaining device 9B, which is optionally provided. When the second retaining device 9B or the end position in the closed position is reached, the second drive unit 2B is held in position by a latching element 92 of the second retaining device 9B in a force-locking but releasable manner. Alternatively, it is also possible for the sliding door 5 to be held in this end position by the closing device 1. A dotted line shows that the closing device 1 is provided with a pull rope 13, which is connected to the second retaining device 9B or to the second rail end piece 82 of the running rail 8. When the sliding door 5 is opened, the pull rope 13 is pulled out of the closing device 1 and the tension spring 15 connected thereto is tensioned.

The sliding door 5 can be gripped manually at a handle 51, released from the second retaining device 9B and pulled to the right in the direction of the first retaining device 9A. During this process, the tension spring in the closing device 1 is tensioned. In the end position, after the sliding door 5 has been opened, the first drive unit 2A is held in a force-locking but releasable manner by a latching element 92 of the first retaining device 9A. The tension spring 15 of the closing device 1 is loaded in this position and can automatically move the sliding door 5 back to the left into the closed position after it has been manually released from the first retaining device 9A. During this process, the pull rope 13 is pulled back into the closing device 1.

The retaining devices 9A, 9B can also be realised in other ways, for example by magnets or locks, which are provided inside or outside the running rail 8. In preferred embodiments, a locking device is provided within the closing device 1, which is activated by an actuating element when the end position is reached.

The closing device 1 with the tensioned tension spring 15 is activated by the user, for example by pulling the handle 51 or by actuating an electromechanical element.

FIG. 2a shows the upper part of the sliding door device 100 FIG. 1 with the closing device 1, with the two holding devices 9A, 9B and with the two drive units 2A, 2B, which are anchored in a mounting groove 50 at the upper edge of the sliding door 5 by means of mounting rails 3A, 3B. The sliding door 5 or the wooden panel with the mounting groove 50 can, for example, be connected to the drive units 2A, 2B by means of the connecting devices as disclosed in U.S. Pat. No. 9,341,019B2.

The two drive units 2A, 2B each have a drive body 20, which holds two rollers or pairs of rollers 29 and which is connected by a threaded rod 21 to a mounting block 22, which is slidably held and fixed in the associated mounting rail 3A, 3B.

The two retaining devices 9A, 9B each have a retaining body 90 and a latching element 92, which forms an elastic and curved retaining arm that can engage over and hold the facing rollers 29 of the facing drive unit 2A or 2B as soon as it reaches the end position. Alternatively, the latching element 92 can also co-operate with the drive body 20.

The closing device 1, from which the pull rope 13 is guided to the second retaining device 9B, comprises a device body 10, which optionally holds a support wheel 199 at the front and which is provided at the rear with a force-locking, form-locking or one-piece connection device 18, by means of which the closing device 1 is connected to the drive body 20 of the first drive unit 2A.

FIG. 2b shows the second retaining device 9B, the closing device 1, the two drive units 2A, 2B and the associated mounting rails 3A, 3B without the running rail 8. Mounting bodies 22 are held in the mounting rails 3A, 3B, which are fixed by means of a locking screw 221 and connected to the drive body 20 of the associated drive unit 2A, 2B by a connecting part, a threaded rod or a connecting screw 21.

FIG. 3 shows the closing device 1 of FIG. 1 in a preferred embodiment. The closing device 1 comprises a device body 10, a displaceable first roller set 11 with four coaxially aligned first cable pulleys 111, 112, 113, 114, which are held by a first mounting shaft 110, a second roller set 12 with three coaxially aligned second cable pulleys 121, 122, 123, which are held by a second mounting shaft 120, a tension spring 15, which is guided around a deflection pulley 19 (symbolically shown) and is connected to the first roller set 11 by a first spring end piece 151 and to the device body 10 by the second spring end piece 152, and a pull rope 13, which is guided around the first cable pulleys 111, 112, 113, 114 of the first roller set 11 and around the second cable pulleys 121, 122, 123 of the second roller set 12 and is connected directly or indirectly to the first roller set 11 or the device body 10 by a first rope end piece 131 and is guided out of the device body 10 through an exit opening 106 by a second rope end piece 132.

The device body 10 can have a one-piece or multi-piece structure and be made of metal and/or plastic. The part of the device body 10 that comprises the holding rail 101 can advantageously be manufactured from plastic or metal in an extrusion process. The closing device form-locking covered or closed by means of side walls 108, possibly a casing or cover. The holding rail 101 is plate-shaped and has a guiding track 1011 on each side.

The device body 10 has a connection device 18 on a rear end piece, which is connected or connectable to the drive body 20 of the associated drive unit 2A form-fittingly and/or force-fittingly or in one piece. The connection device 18 is connected in one piece, or connectable force-fittingly and/or form-fittingly to the device body 10, optionally screwable. At the front end piece, the device body 10 has an axle bearing 109, by which a wheel axle 1990 is held, by means of which the optionally provided support wheel 199 is rotatably mounted. At the front end, the device body 10 holds the second mounting shaft 120 and the stationary second roller set 12.

The tension spring 15 is preferably made of rubber, plastic or metal or a braid of rubber, plastic or metal and is preferably provided with a sheathing 155, for example a braid of plastic threads (see FIG. 5a). Preferred materials for manufacturing the tension spring 15 and the sheathing 155 are described above.

In this preferred embodiment, the device body 10 comprises a holding rail 101, from which a roller carriage 14 is displaceably held. The roller carriage 14 has a carriage body 140, from which the first mounting shaft 110 and the first roller set 11 are held. The carriage body 140 also holds or comprises a first coupling device 142, which holds the first spring end piece 151 form-fittingly and/or force-fittingly. On the lower side, the carriage body 140 has guide elements 141 on both sides in the form of skids, which form-fittingly enclose guiding tracks 1011 of the holding rail 101, which has at least approximately a T-profile. The roller carriage 14 with the first roller set 11 can be moved over almost the entire length of the rail body 101 up to the stationary second roller set 12.

The holding rail 101 has a track entrance 1010, which allows the roller carriage 14 or the guide elements or skids 141 to be form-fittingly coupled to the holding rail 101. The track entrance 1010 is closed with a locking screw 1019 so that the roller carriage 14 cannot automatically detach from the holding rail 101.

When the sliding door 5 is opened, the pull rope 13 is pulled out of the closing device 1, causing the roller carriage 14 with the first roller set 11 to be pulled against the second roller set 12. During this movement, the length of the loops surrounding the two roller sets 11, 12 is shortened, which is why the pull rope 13 is released by the corresponding amount. At the same time, the tension spring 15 is pulled around the deflection pulley 19 and tensioned to its maximum length and charged with energy, which is released as soon as the sliding door 5 is released from its end position. The roller carriage 14 is pulled back into the other end position by the tension spring 15, whereby the pull rope 13 is reinserted into the closing device 1 and the sliding door 5 is automatically moved back into the closed position.

FIG. 3 also shows an example of the first rope end piece 131, which is guided to a threaded hole 107 in the device body 10 or to a threaded hole 147 in the carriage body 140 and fixed there by means of a mounting screw 7. FIG. 6 shows that the device body 10 or the carriage body 140 can also be fitted with a differently designed cable connection device 105 or 145, into which the first rope end piece 131 can be hooked, for example. The cable connection devices 105 or 145 are, for example, hooks, clips or clamps. Preferably, the first rope end piece 131 is connected to the roller carriage 14 so that the pull rope 13 can also be pulled out of the closing device 1 by the amount of the displacement of the roller carriage 14.

FIG. 4a shows a part of the closing device 1 of FIG. 3 with the tension spring 15, which is guided around a deflection pulley 19 and is connected to the first coupling device 142 of the roller carriage 14 by the first spring end piece 151. It is shown that the spring end pieces 151, 152 have coupling parts 1510, 1520, which can be form-fittingly connected on the one hand to the first coupling device 142 of the coupling carriage 14 and to a second coupling device 16 on the device body 10 (see FIG. 5a).

FIG. 4b shows the part of the closing device 1 of FIG. 4a with the roller carriage 14 displaced against the stationary second roller set 12. The tension spring 15 is partially tensioned and the pull rope 13 has been partially pulled out of the closing device 1.

A larger double-headed arrow and a smaller double-headed arrow symbolise optional damping devices 17, which dampen the movement of the roller carriage 14 when it is returned. The longer double arrow symbolises that the movement of the roller carriage 14 can be damped over the entire return path. The smaller double arrow symbolises that the movement of the roller carriage 14 can also be damped over only part of the return path. Also shown is a damping device 17, which has been removed from one of the holding devices 9A, 9B and which has a damping cylinder 171 and a push rod 172, by means of which a damping piston can be displaced within the damping cylinder 171. The damping piston is surrounded by a layer of oil, for example, or is intended to displace air from the damping cylinder 171. Typically, a damping device 17 of this type comprises a return spring by means of which the damping piston is returned to the starting position and the push rod 172 is pushed outwards, for example. For example, as shown in FIG. 2a for the holding devices 9A, 9B, the damping device 17 is inserted into a bore in the device body 10 or in the carriage body 140, so that the push rod 172 or the damping cylinder 171, which is preferably provided with an elastic element at the front, is aligned against the roller carriage 14 or against a part of the device body 10 and can co-operate with the latter before the sliding door 5 or the roller carriage 14 reaches the end position.

FIG. 5a shows the device body 10 of the closing device 1 of FIG. 3 with the deflection pulley 19 and the roller carriage 14 as well as with the tension spring 15, which has been released from the device body 10 and the roller carriage 14. In this configuration, the optional support wheel 199 has been removed. As a result, the second coupling device 16 is visible, which allows the coupling piece 1520 of the second spring end piece 152 to be hooked in. In a preferred embodiment, the second coupling device 16 is adjustable by means of an adjusting screw 161 and can be displaced parallel to the holding rail 101, which has an upper side 101T and a lower side 101B.

After assembly, the tension spring 15 is guided around the deflection pulley 19 in such a way that the first spring end piece 151 runs along the upper side 101T of the holding rail 101 and the second spring end piece 152 runs along the lower side 101B of the holding rail 101. The two spring end pieces 151, 152 are preferably aligned parallel to each other. The first spring end piece 151 is connected with the first coupling part 1510 to the first coupling device 142 of the roller carriage 14. The second spring end piece 152 is connected to the second coupling part 1520 with the preferably adjustable second coupling device 16. It is shown that the tension spring 15, which is preferably made of rubber, preferably has a sheathing 155, which preferably consists of a braid of rubber fibres or plastic fibres.

FIG. 5b shows the device body 10 of FIG. 5a and the detached roller carriage 14, which has been rotated by 180° with the first coupling device 142, which is provided for the form-locking coupling of the first end piece 151 of the tension spring 15.

FIG. 6 shows the closing device 1 of FIG. 3 with the device body 10 and the connection device 18, which is connected or connectable to the drive body 20 of the associated drive unit 2A form-fittingly and/or force-fittingly or in one piece.

FIG. 7 shows an inventive closing device 1 in a further preferred embodiment with a modular device body 10, which comprises a holding rail 101, a connecting body 102, which forms the device body of the connection device 18, and a terminating body 103, which holds the second roller set 12. The connecting body 102 is inserted on one side of the holding rail 101 and the terminating body 103 is inserted on the other side of the holding rail 101 and held detachably. The connecting body 102 and/or the terminating body 103 are form-fittingly displaceable into the holding rail 101 and are preferably held without play perpendicular to the longitudinal axis x of the closing device 1. The holding rail 101, the connecting body 102 and/or the terminating body 103 are therefore form-fittingly connected to each other and thus form the device body 10.

The tension spring 15 is connected with the first spring end piece 151 to the first coupling device 142 of the roller carriage 14 and with the second spring end piece 152 to the second coupling device 16, which is preferably an integral part of the terminating body 103.

The tension spring 15 is tensioned and pulls the connecting body 102 and the terminating body 103 against the holding rail 101 and thus against each other. The device body 10, which consists of the holding rail 101, the connecting body 102 and the terminating body 103, is therefore held together by the tension spring alone.

The preferably symmetrically designed holding rail 101, which is shown in a longitudinal section along the longitudinal axis x, has preferably a downwardly open U-profile or C-profile with a centrepiece 101X, which is adjoined on both sides by side walls 101Y. Guiding tracks 1011, for example holding channels or holding grooves, are arranged on the inner sides of the side walls 101Y, in which guide elements 141 of the roller carriage 14, as well as first support elements 1021 of the connecting body 102 and second support elements 1031 of the terminating body 103 engage in a form-fitting manner. The guide elements 141, the first support elements 1021 and the second support elements 1031 are preferably of identical design. However, the guide elements 141 can also be designed as rollers or be made of a material, such as POM, which has a high sliding ability. In the embodiment shown, the carriage body 140 is provided with two cylindrical guide elements 141, the connecting body 102 with two cylindrical first support elements 1021 and the terminating body 103 with two cylindrical holding elements 1031, which are spaced apart from one another and each project into the associated channel-shaped guiding track 1011 in the side wall 101Y of the holding rail 101. FIG. 7 also shows that the connecting body 102 has a connecting plate 1022 and the terminating body 103 has a terminating plate 1032, which allow the holding rail 101 to be terminated on both sides. Furthermore, the pull rope 13 is shown schematically, which is preferably mounted as in the closing device 1 of FIG. 3. In the embodiment of the closing device 1 of FIG. 7, no covers are required compared to the embodiment of FIG. 5, as the holding rail 101 is closed on three sides.

FIG. 8 shows the closing device 1 of FIG. 7 during assembly. The holding rail 101 is shown shortened. The arrows symbolise that the roller carriage 14, the connection device 18 with the connecting body 102 and the terminating body 103 can be inserted into the holding rail 101 in the same way. The pull rope 13, which is not shown, has already been fitted and can be inserted into the holding rail 101 through the lower opening.

The tension spring 15 has already been passed through the connection device 18 and connected to the roller carriage 14, so that the closing device 1 can be assembled in a few simple steps. After inserting the roller carriage 14, the connection device 18 and the terminating body 103, the second end piece 152 of the tension spring 15 protrudes downwards and only needs to be tensioned and connected to the second coupling device 16. Once the tension spring 15 has been fitted, the assembly of the closing device 1 is complete.

FIG. 9a shows the connection device 18 with the connecting body 102 and the deflection pulley 19 detached from the connecting body 102 with the bearing shaft 190. The connecting body 102 is fork-shaped and has two legs, between which the deflection pulley 19 can be mounted by means of the bearing shaft 190.

FIG. 9b shows the connecting body 18 of FIG. 9a from the other side with a coupling element 181, through which the closing device 1 can be connected to a drive unit 2A according to FIG. 1.

FIG. 9c shows the terminating body 103, which carries the second roller set 12 and which preferably holds a support wheel 199, which can roll in the running rail 8 of FIG. 1.

List of references:

| | |
|---|---|
| 1 | closing device |
| 100 | sliding door device, arrangement with a sliding element 5 |
| 10 | device body |
| 101 | holding rail |
| 101B | lower side of the holding rail |
| 101T | upper side of the holding rail |
| 101X | centrepiece |
| 101Y | side walls |
| 1010 | track entrance |
| 1011 | guiding tracks |
| 1019 | locking screw |
| 102 | connecting body |
| 1021 | first support elements |
| 1022 | connecting plate |
| 103 | terminating body |
| 1031 | second support elements |
| 1032 | terminating plate |
| 105 | cable connection device at the device body 10 |
| 106 | exit opening |
| 107 | threaded hole in the device body 10 |
| 108 | covers |
| 109 | axle bearing |
| 11 | first roller set |
| 110 | first mounting shaft |
| 111-114 | first cable pulleys |
| 12 | second roller set |
| 120 | second mounting shaft |
| 121-123 | second cable pulleys |
| 13 | pull rope |
| 131 | first rope end piece 13 |
| 132 | second rope end piece 13 |
| 14 | roller carriage |
| 140 | carriage body |
| 141 | guide elements |
| 142 | first coupling device |
| 145 | cable connection device at the roller carriage 14 |
| 147 | threaded hole in the carriage body 140 |
| 15 | tension spring |
| 151 | first spring end piece |
| 1510 | first coupling part at the first spring end piece 151 |
| 152 | second spring end piece 15 |
| 1520 | second coupling part at the second spring end piece 152 |
| 155 | sheathing |
| 16 | second coupling device at the device body 10 |
| 161 | adjusting screw |
| 17 | damping device |
| 171 | damping cylinder |
| 172 | push rod |
| 18 | connection device |
| 181 | coupling element |
| 19 | deflection pulley |
| 190 | bearing shaft |
| 199 | support wheel |
| 1990 | wheel axle |
| 2A, 2B | drive units |
| 20 | drive body |
| 21 | connecting part, connecting shaft, connecting screw |
| 22 | mounting body |
| 221 | locking screw |
| 3A, 3B | mounting rails |
| 5 | sliding door, displaceable element |
| 50 | mounting groove |
| 51 | door handle |
| 7 | mounting screw |
| 8 | running rail |
| 81 | first rail end piece |
| 82 | second rail end piece |
| 9A, 9B | retaining device, buffer device |
| 90 | retaining body |
| 91 | stop damper |
| 92 | latching element |

1. A closing device for a sliding door device with at least one sliding door, comprising a device body, a first roller set that is held displaceable, a second roller set that is held stationary by the device body, a tension spring, which is connected by a first spring end piece directly or indirectly to the first roller set and which is connected by a second spring end piece directly or indirectly to the second roller set, and a pull rope, which is guided with several loops around the first roller set and the second roller set and which is connected with a first rope end piece directly or indirectly to the first roller set or to the device body and which is led out of the closing device with a second rope end piece, wherein,
that the device body comprises a holding rail, which displaceably holds a roller carriage that comprises a carriage body,
that the roller carriage is coupled to the first spring end piece and is provided with a first mounting shaft by which the first roller set is rotatably supported,
that the device body is integrally, force-fittingly or form-fittingly connected to a connection device which is connected or connectable to a drive body of a drive unit, and
that the connection device by means of a bearing shaft rotatably holds a deflection pulley around which the tension spring is guided.

2. The closing device according to claim 1, wherein the tension spring is helical or cylindrical and consists of metal, plastic or rubber or that the tension spring consists of a plurality of bundled threads of rubber.

3. The closing device according to claim 1, wherein the tension spring is enclosed by a sheathing.

4. The closing device according to claim 3, wherein the sheathing is a stretchable coating or a stretchable braid.

5. The closing device according
claim 1, wherein the device body comprises a connecting body which is connectable to a first end piece of the holding rail and which forms a structural element of the connection device; or
that the device body comprises a terminating body which is connectable to a second end piece of the holding rail and which is provided with a second mounting shaft by which the second roller set is rotatably held; or
that the device body comprises a connecting body which is connectable to a first end piece of the holding rail and which forms a structural element of the connection device, and that the device body comprises a terminating body which is connectable to a second end piece of the holding rail and which is provided with a second mounting shaft by which the second roller set is rotatably held.

6. The closing device according to claim 5,
wherein the holding rail has one or more guiding tracks along which the roller carriage is displaceably mounted,
that the carriage body has one or more guide elements, which are held by one of the guiding tracks;
that the connecting body comprises one or more first support elements which are held by one of the guiding tracks; or
that the terminating body comprises one or more second support elements which are held by one of the guiding tracks; or
that the connecting body comprises one or more first support elements which are held by one of the guiding tracks and that the terminating body comprises one or more second support elements which are held by one of the guiding tracks.

7. The closing device according to
claim 1, wherein the first spring end piece has a first coupling part which is held by a first coupling device which is fixedly or displaceably connected to the carriage body of the roller carriage, or
that the second spring end piece comprises a second coupling part which is held by a second coupling device which is fixedly or slidably connected to the device body, or
that the first spring end piece has a first coupling part which is held by a first coupling device which is fixedly or displaceably connected to the carriage body of the roller carriage, and that the second spring end piece comprises a second coupling part which is held by a second coupling device which is fixedly or slidably connected to the device body.

8. The closing device according to
claim 6, wherein the connection device is pulled by the tension spring against the first end piece of the holding rail and is held with the connecting body at the first end piece of the holding rail, or
that the terminating body is pulled against the second end piece of the holding rail by the tension spring and is held at the second end piece of the holding rail, or
that the connection device is pulled by the tension spring against the first end piece of the holding rail and is held with the connecting body at the first end piece of the holding rail, and that the terminating body is pulled against the second end piece of the holding rail by the tension spring and is held at the second end piece of the holding rail.

9. The closing device according to
claim 1, wherein the holding rail is plate-shaped and has an upper side and a lower side and that the first spring end piece is guided from the deflection pulley on the upper side of the holding rail to the roller carriage and that the second spring end piece is guided from the deflection pulley on the lower side of the holding rail to the second coupling device; or
that the holding rail is formed in the shape of a C-profile or U-profile and has two side walls which are connected to one another by a centrepiece and on the inner sides of which side walls, which face one another, one of the guiding tracks is provided in each case, and that the first spring end piece is guided from the deflection pulley into the holding rail to the roller carriage and that the second spring end piece is guided from the deflection pulley on the lower side of the holding rail to the second coupling device.

10. The closing device according to claim 7, wherein the carriage body and the device body are connected to each other by a damping device.

11. The closing device according to claim 1, wherein the guide elements of the roller carriage as well as the first support elements of the connecting body and the second support elements of the terminating body are held so as to be displaceable in or by the guiding tracks of the holding rail in a form-locking manner.

12. The closing device according to claim 1, wherein the pull rope with the second rope end piece is led out of the closing device through an exit opening and that the second roller set is arranged in the region of the exit opening and the first roller set is arranged remote from the exit opening.

13. A sliding door device with at least one sliding door and with a closing device according to claim 1.

14. The sliding door device according to claim 13, wherein the sliding door is connected on the upper side to a first drive unit and to a second drive unit, which are displaceably mounted in a running rail, and that one of the drive units is connected to the closing device, from which the pull rope, which is held in the closing device by a first rope end piece, is led out and is connected by a second rope end piece directly or indirectly to the running rail or to a retaining device provided therein.

15. The sliding door device according to claim 13, wherein the running rail extends from a first rail end piece to a second rail end piece and that at least in the first rail end piece a first retaining device with a latching element is arranged, by means of which the sliding door is releasably lockable in a position in which the tension spring is tensioned, and that the second rail end piece is directly or indirectly connected to a rail piece remote from the first rail end piece or to the second rail end piece.
